(19) United States
(12) Patent Application Publication
(10) Pub. No.: US 2017/0339931 A1
(43) Pub. Date: Nov. 30, 2017

(54) FISHING BAIT ADAPTER

(71) Applicant: Curt Farris, Kenner, LA (US)

(72) Inventor: Curt Farris, Kenner, LA (US)

(21) Appl. No.: 15/169,176

(22) Filed: May 31, 2016

(51) Int. Cl. A01K 83/06; A01K 97/00; A01K 91/06

(52) U.S. Cl. CPC A01K 83/06; A01K 91/06; A01K 97/00

(57) ABSTRACT

The bait tackle device makes the process of adjusting one's fishing gear faster and easier. It allows one to quickly interchange plastic lures as well as quickly appropriate live and/or artificial bait. The bait tackle device allows one to quickly change weights without cutting one's line. Further, it allows one to use a treble hook which can be used with removable or threadable bait.

### CROSS REFERENCE TO RELATED APPLICATIONS

Not applicable

### REFERENCE TO GOVERNMENT FUNDING SOURCES

Not applicable.

### REFERENCE TO SEQUENCE LISTING

Not applicable.

### FIELDS OF THE INVENTION

The disclosure as detailed herein is in the technical field of sports. More specifically, the present disclosure relates to the technical field of fishing. Even more specifically, the present disclosure relates to the technical field of bait tackle.

### DESCRIPTION OF RELATED ART

People who go fishing are often challenged by the need to cut their line multiple times in order to correct weight, hook type, and/or switch bait type in order to achieve success. These adjustments to one's gear can take considerable time and expense. Fishing gear adjustment challenges exist for those using a weighted single hook bait and tackle device, for those using a variety of weighted tackle devices, and for those who use sliding weights along with a hook.

Fisher persons must often spend considerable time changing weights and devices as well as cutting and replacing lines. Fisher people often spend significant time and resources purchasing and deploying weighted jigheads in order to fish in a variety of environments and conditions. Fishing people who use plastic lures can utilize both artificial and/or live bait. When a fishing person uses a plastic lure he/she faces the challenges of threading the hook along the curves of the lure; this threading process can often be inaccurate.

Threading the hook along the curves of the lure often leads to faster expiration of live bait and can decrease the naturalness of the lure. Threading the hook can be a difficult process for inexperienced fisher persons such as children who are learning to fish. Many fisher people prefer a treble hook to a single hook. Using a single hook may lead to losing a fish on the line and the use of a treble hook can lead to a better catch.

### GENERAL SUMMARY OF THE INVENTION

The bait tackle device makes the process of adjusting one's fishing gear faster and easier. It allows one to quickly interchange plastic lures as well as quickly appropriate live and/or artificial bait. The bait tackle device allows one to quickly change weights without cutting one's line. Further, it allows one to use a treble hook which can be used with removable or threadable bait.

An embodiment of the instant invention allows one to interchange your plastic lures.

Yet another embodiment of the invention allows one to interchange your live bait very quickly.

Yet another embodiment of the invention allows one to change weights using the same bait tackle device.

Yet another embodiment of the invention allows one to change weights without cutting their line.

Yet another embodiment of the invention allows one to change weights rapidly.

Yet another embodiment of the invention allows one to use a three barb treble hook to be used with removable/threadable bait.

Yet another embodiment of the invention allows one to catch more fish.

Yet another embodiment of the invention allows one to change bait very quickly.

Yet another embodiment of the invention allows one to change a treble hook with different bait types without cutting their line.

An additional embodiment allows one to use a treble hook with artificial or live bait.

### DESCRIPTION OF FIGURES

FIG. 1 is a diagram view which shows how to use the bait tackle device.

FIG. 2 is a perspective view which shows plastic bait threaded on the device with a weight attached.

FIG. 3 is a perspective view which shows plastic bait threaded on the device without a weight attached.

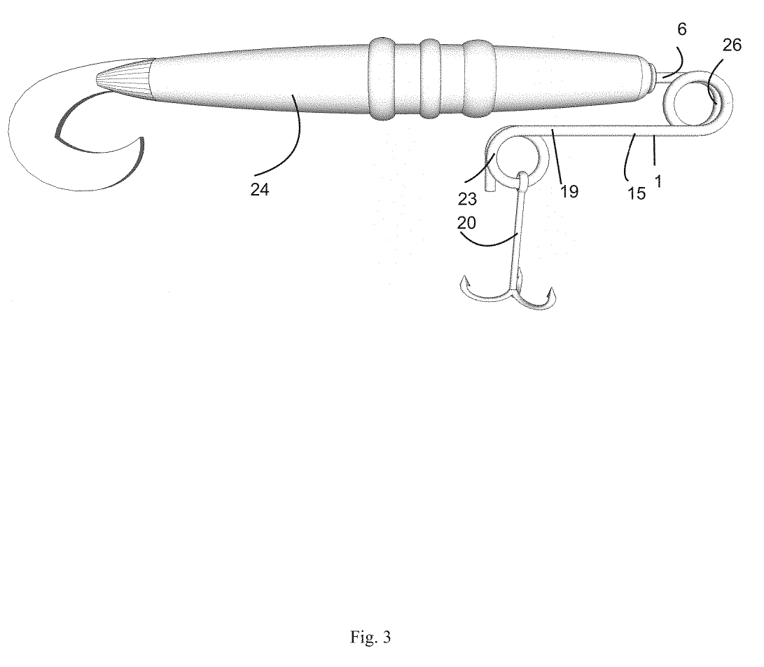

FIG. 4 is a perspective view which shows the device with a treble hook attached.

FIG. 5 is a perspective view which shows the device with a treble hook attached and the broad regions of the device.

FIG. 6 is a perspective view which shows live bait threaded on the device without a weight attached.

FIG. 7 is a perspective view which shows the device with a treble hook attached and the various regions of the threading arm.

FIG. 8 is a perspective view which shows alternative plastic bait threaded on the device without a weight attached.

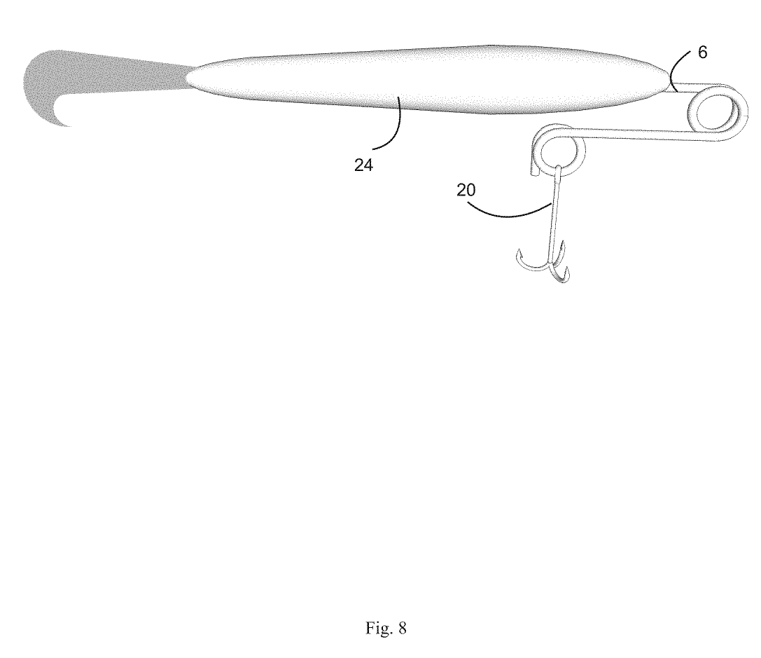

FIG. 9 is a perspective view which shows alternative plastic bait threaded on the device without a weight attached and a hook instead of a treble hook.

FIG. 10 is a perspective view which shows an embodiment with a curved portion on threading arm.

FIG. 11 is a perspective view which shows an embodiment with an angle within the hook arm.

FIG. 12 is a perspective view which shows an embodiment with different eye types not constructed from loops.

FIG. 13 is a perspective view which shows non-live bait threaded on the device.

FIG. 14 is a perspective view which shows an embodiment with an extended hook arm and extra eye.

### DETAILED DESCRIPTION OF THE INVENTION

A preferred embodiment of the present invention is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person of ordinary skill in the relevant art will recognize that other configurations and arrangements can be used without departing from the spirit and scope of the invention. It will be apparent to a person of ordinary skill in the relevant art that this invention can also be employed in a variety of other systems and applications.

The invention has some elements that are commonly known and also terms defined for the purposes of this specification including: a treble hook 20, a hook arm/threading span 5, a hook 25, bait 24, and finally a minimum bait threading distance 2. However their use and relationships to the novel components and steps of the invention render them applicable herein.

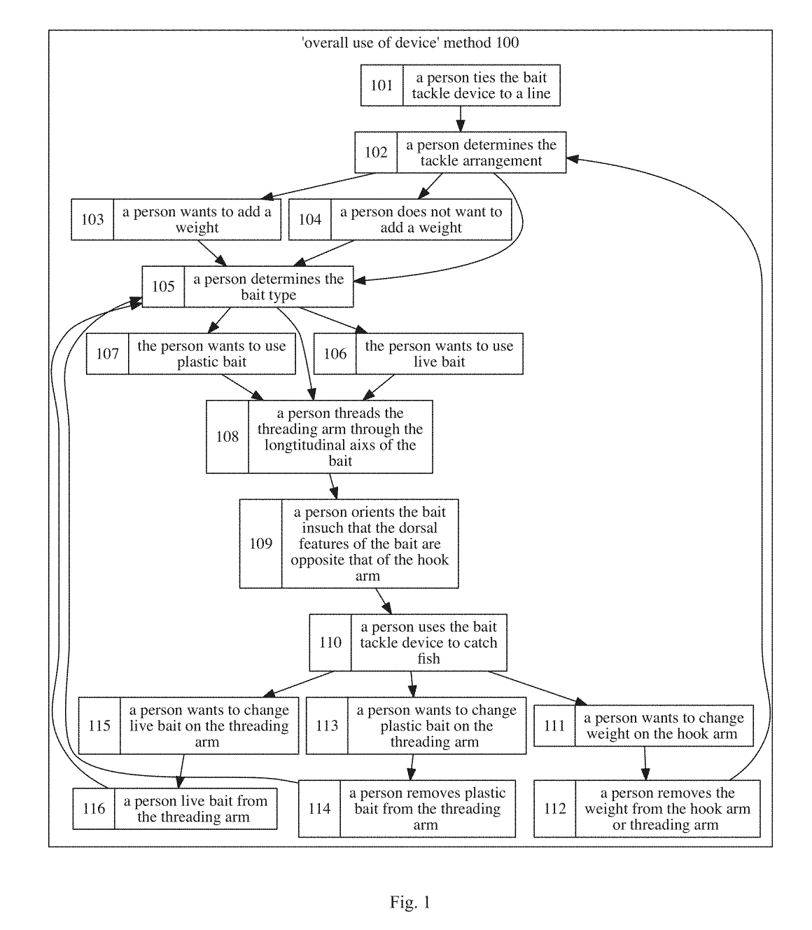

In order to use the invention one would first tie a bait tackle device (the instance invention) to a line through the eye 26 (FIG. 1) The bait tackle device 11 is mainly thought to be composed of steel, however other embodiments may be composed of any of the following: high carbon steel, steel alloyed with Vanadium, stainless steel, fishing leader wire, or corrosion resistant steel. It allows one to change bait very quickly and change weights very quickly without cutting ones line, in order to catch more fish. The bait tackle device 11 preferably comprises an eye 26, a threading arm 17, and finally a hook arm 22.

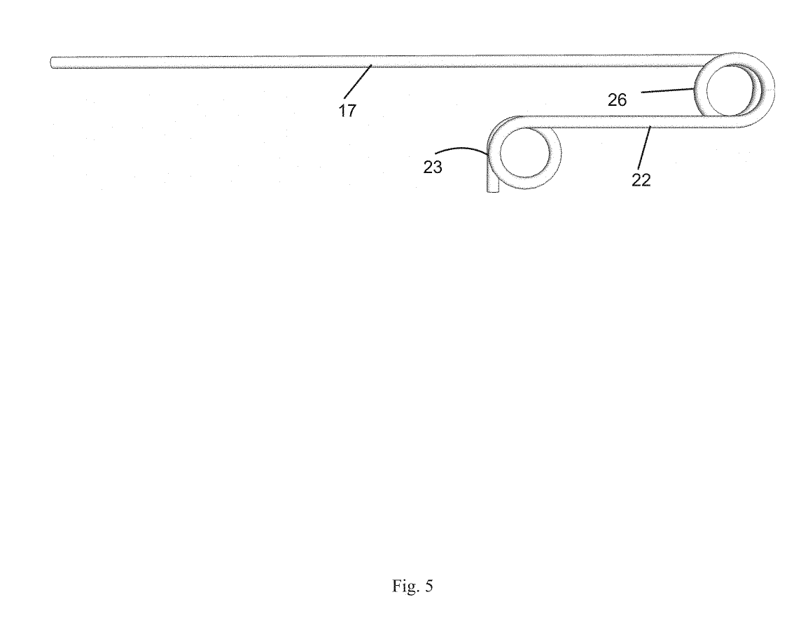

Spatially, the eye 26 is preferably positioned above the threading arm 17 and above the hook arm 22 (FIG. 5). The eye 26 is attached to the fishing line. The eye 26 comprises the point where the bait tackle device 11 is connected to a line or attachments that attach to a line. In some embodiments, it is thought that examples of an eye 26 may include: a ring eye, a ball eye, a brazed eye, a tapered eye, a looped eye, a needle eye, or a spade end. The eye 26 has an alternative embodiment herein termed the ‘twisted to form loop’ embodiment. The ‘twisted to form loop’ embodiment has a twisted loop which is an eye 26 created from a single piece wherein a loop is formed by twisting and the two strands form other parts of the bait tackle device 11. It allows one to adjust the hook arm/threading arm span in order to accomodate different bait sizes.

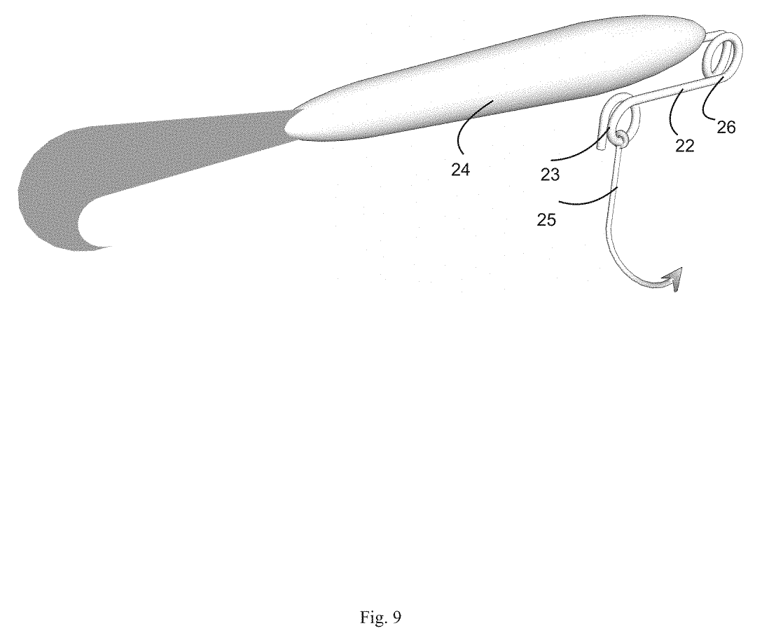

Next, a person determines the tackle arrangement (FIG. 1), including choosing a treble hook 20 or hook 25 and attaching it to the hook eye 21. A treble hook 20 (FIG. 5) comprises a component for catching fish that has three hooks welded together. In some embodiments, it is thought that examples of a treble hook 20 may include: a short shank treble hook, a standard shank treble hook, a round bend treble hook, an extra-wide gap treble hook, a standard wire treble hook, or a 2x or heavy wire treble hook. A hook 25 (FIG. 9) comprises a device for catching fish either by impaling them in the mouth, normally attached to some form of line or lure device. In some embodiments, it is thought that examples of a hook 25 may include: a floating worm hook, an offset worm hook, a saltwater jig hook, a red bait hook, a saltwater bend back hook, a sproat hook, a sneck hook, a limerick hook, a kendal hook, a viking hook, a captain hamilton hook, a barleet hook, a swimming nymph hook, a bend back hook, a model perfect hook, a keel hook, or a kink-shank hook.

The hook eye 21 (FIG. 5) comprises the point where the hook region is connected to one or more hook(s) or treble hook(s). In some embodiments, it is thought that examples of a hook eye 21 may include: a ring eye, a ball eye, a brazed eye, a tapered eye, a looped eye, a needle eye, or a spade end. The hook eye 21 has an alternative embodiment herein termed the hook ‘twisted to form loop’ embodiment. The hook ‘twisted to form loop’ embodiment is a hook eye 21 created from a single piece wherein a loop is formed by twisting into a circle. It allows one to slide on a hook or intereving ring attached to a hook and attach a ring or jig.

Next, if a person wants to add a weight or attachment, they may do it at various places on the tackle device. Specifically, in the non-hook front attachment region 1 or in the front attachment region 6 with a non-hook front attachment 3 or a front attachment 14, respectively.

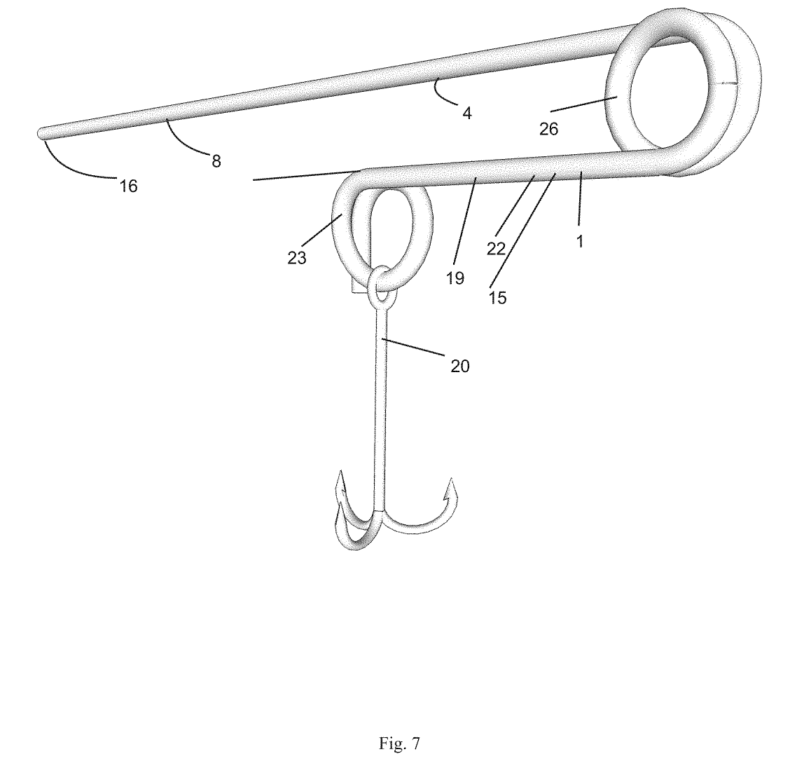

Spatially, the non-hook front attachment region 1 (FIG. 7) is preferably positioned above the hook region and within the non hook region 19. The non-hook front attachment region 1 comprises the part of the non hook region 19 that may be used for attachments (such as weights). It functions to both 1) allow one to change weights rapidly using the same bait tackle device and to 2) allow one to change their weights without cutting their line. The non-hook front attachment region 1 preferably comprises the non-hook front attachment 3. Spatially, the non-hook front attachment 3 is preferably positioned above the hook region 19 and within the non-hook front attachment region 1. The non-hook front attachment 3 comprises a fishing component that may otherwise be attached to the non-hook front attachment region 1. One goal of the non-hook front attachment 3 is to correctly orient the dorsal ventral position of the bait and the hook region by adding a weight to as the non-hook front attachment 3. In some embodiments, it is thought that examples of a non-hook front attachment 3 may include: balls, beads, floats, an avon float, a bubble float, a dink float, a popper float, a quill float, a self-cocking float, a stick float, pyramid sinkers, barrel or egg sinkers, split-shot sinkers, bullet sinkers, a dipsey, a bank sinker, or a rattle. In some embodiments, it is thought that if the non-hook front attachment 3 is absent then the non-hook front attachment region 1 may not have an attachment.

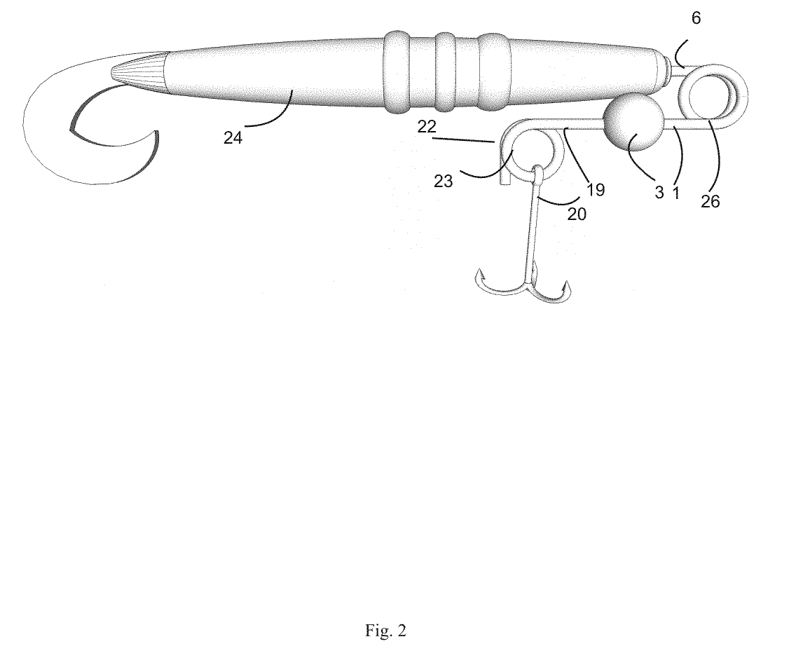

Similar to the non-hook front attachment region 1, the front attachment region 6 (FIG. 2) is preferably positioned above the bait threading region and within the non bait threading region 4. The front attachment region 6 comprises the part of the non bait threading region 4 that may be used for attachments (such as weights) while the bait 24 is on the threading arm 17. The front attachment region 6 functions to both 1) allow one to change weights rapidly using the same bait tackle device and to 2) allow one to change their weights without cutting their line in order to do so. In some embodiments, it is thought that if the front attachment region 6 is absent then the bait may be slid all the way up to the eye on the threading arm 17. The front attachment region 6 preferably comprises the front attachment 14. The front attachment region 6 has an alternative embodiment herein termed the ‘right angle attachment’ embodiment. This embodiment is an embodiment of the front attachment region where there is immediately a right angle that is formed from the eye, a bend, then the threading arm is run parallel to the hook arm

Spatially, the front attachment 14 (FIG. 2) is preferably positioned above the bait threading region 8 and within the front attachment region 6. The front attachment 14 comprises a fishing component that may otherwise be attached to the front attachment region 6. In some embodiments, it is thought that examples of a front attachment 14 may include: balls, beads, floats, an avon float, a bubble float, a dink float, a popper float, a quill float, a self-cocking float, a stick float, pyramid sinkers, barrel or egg sinkers, split-shot sinkers, bullet sinkers, a dipsey, a bank sinker, or a rattle. In some embodiments, it is thought that if the front attachment 14 is absent then the bait may be slid all the way up to the eye on the threading arm 17.

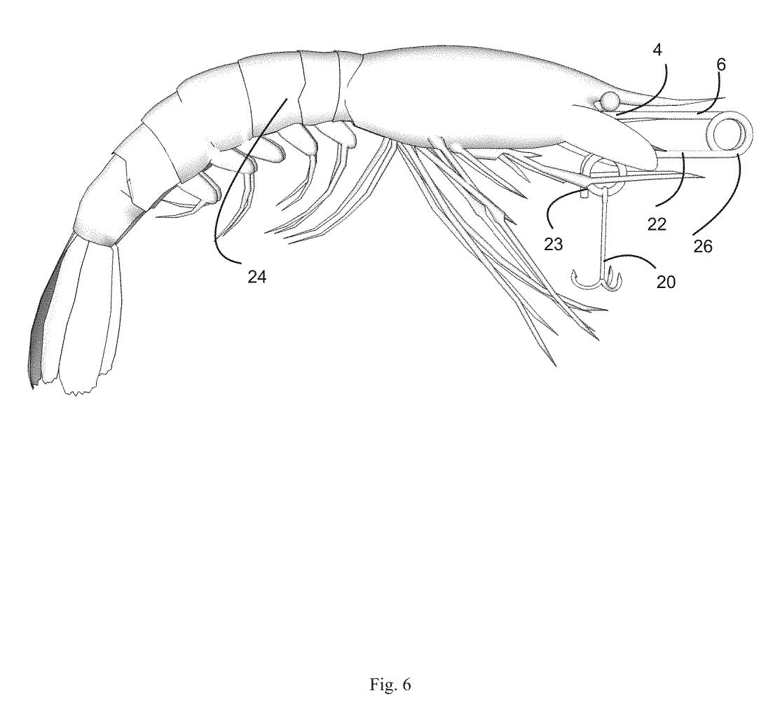

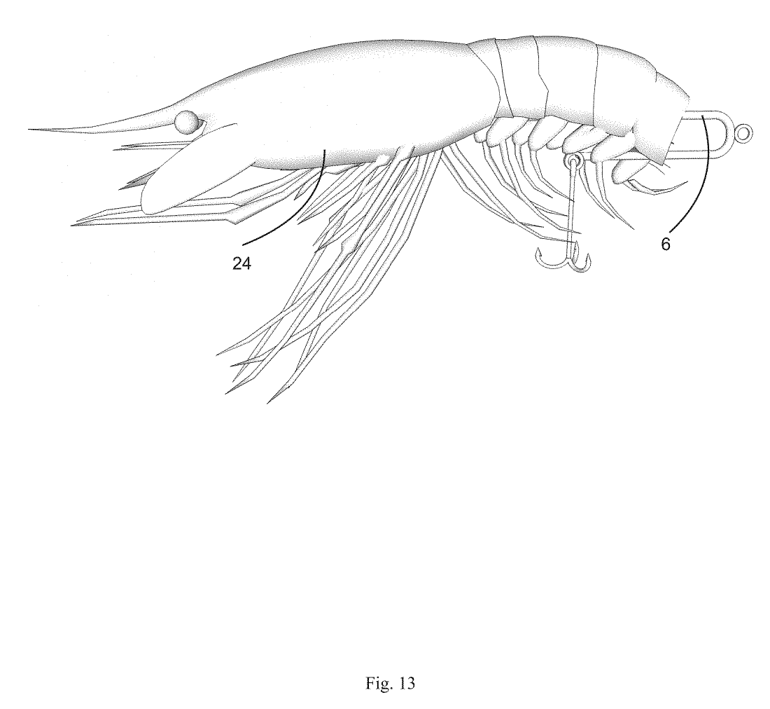

After deciding what types of attachments to use, a person may determine the bait type. Bait comprises a physical substance used to attract and catch fish. In some embodiments, it is thought that examples of a bait 24 may include: surface lures, artificial flies, soft plastic baits (FIG. 2, 8, 9), swimbait, a fish decoy, live bait (FIG. 6), or non-living bait (FIG. 13). For example, if a person want to use live bait 24 they may insert the live bait through the insertion point 16 up the longitudinal axis threading arm 17. If a person wants to use plastic bait they similarly may insert the plastic bait through the insertion point 16 on the longitudinal axis threading arm 17.

During threading, preferably, a person will a have a bait that is longer than the minimum bait threading distance 2 (FIG. 6). The minimum bait threading distance 2 comprises a distance defining the position of effective bait on the threading arm 17, which preferably should be at least as long the length of the hook arm 22. In other embodiments, however one may be have a bait lower than the minimum distance. Further, a person will preferably have a bait that fits within the hook arm/threading span 5 (FIG. 9). The hook arm/threading span 5 which comprises the distance between the threading arm and the hook arm.

Spatially, the threading arm 17 (FIG. 5) is preferably positioned below the eye 26 and parallel to the hook arm 22. The threading arm 17 is mainly thought to be composed of steel, however other embodiments may be composed of any of the following: high carbon steel, steel alloyed with Vanadium, stainless steel, fishing leader wire, or corrosion resistant steel. The threading arm 17 is preferably shaped like straight rod however, it is thought that in alternative embodiments that it may also be shaped like a curved rod or alternatively like a wavy rod.

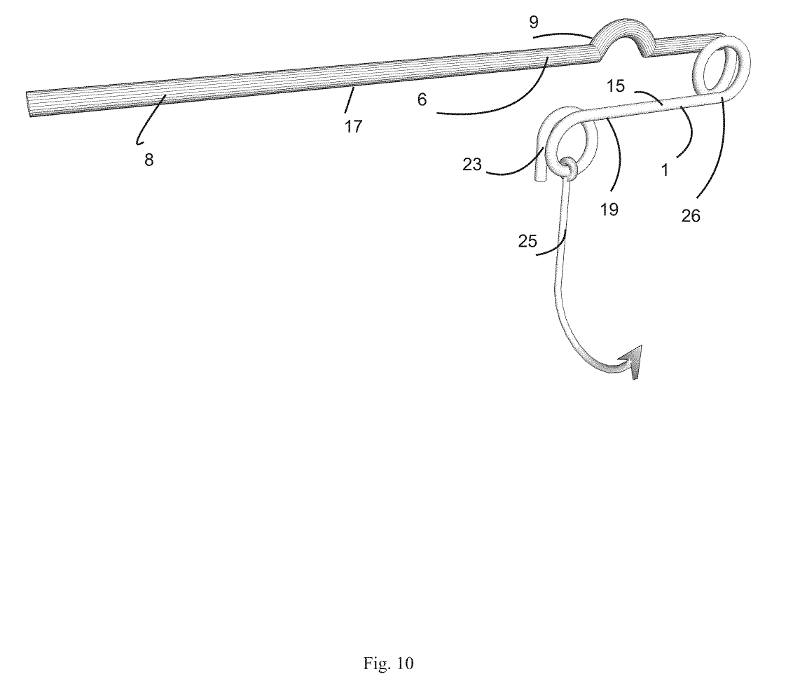

The threading arm 17 comprises the extended portion of the bait tackle device that a person threads through the bait longitudinally. The threading arm 17 has many purposes which are as follows: It allow one to interchange their plastic lures, live and non-live baits and weights quickly. The threading arm 17 preferably comprises the bait threading region 8 and the non bait threading region 4 (FIG. 7). The threading arm 17 has a couple alternative embodiments herein termed the “straight‘ embodiment’ and the ‘with curves’ embodiment. A “straight‘ embodiment’ is one wherein the entire threading region is straight, with no curves or bumps, which allows allow easy insertion into the bait. The ‘with curves’ embodiment (FIG. 10), has threading with curves 9 which comprises a threading region wherein one or more curves or bumps appears within a portion of the threading region or in other embodiments, at the end of the threading region.

Spatially, the bait threading region 8 is preferably positioned below the eye 26 and parallel to the hook arm 22. The bait threading region 8 is mainly thought to be composed of steel, however other embodiments may be composed of any of the following: high carbon steel, steel alloyed with Vanadium, stainless steel, fishing leader wire, or corrosion resistant steel. The bait threading region 8 comprises the portion of the threading arm 17 that surrounds the bait after being inserted through the insertion point 16 and functions to both 1) allow one to interchange plastic lures very quickly and to 2) allow one to interchange live bait very quickly. The bait threading region 8 preferably comprises the insertion point 16.

Spatially, the insertion point 16 (FIG. 7, 11, 12) is preferably positioned at the end of the bait threading region 8. The insertion point 16 comprises the portion of the bait threading region 8 that pokes through bait and is threaded longitudinally through the bait. The insertion point 16 functions to both 1) allow one to thread through soft plastic bait and to 2) allow one to thread through live and non-live bait.

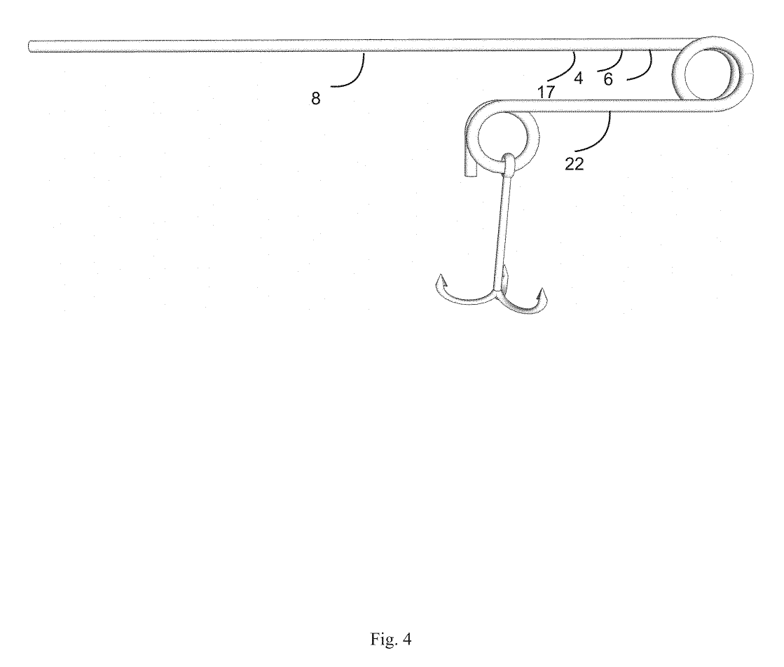

The second region of the threading arm 17 is the non bait threading region 4 (FIG. 4). Spatially, the non bait threading region 4 is preferably positioned above the bait threading region 8 and below the eye 26. The non bait threading region 4 comprises the portion of the threading arm 17 that is typically not surrounded by bait, when the bait is on the device. In some embodiments, it is thought that if the non bait threading region 4 is absent then the bait may be slid all the way up to the eye on the threading arm 17. The non bait threading region 4 preferably comprises the front attachment region 6.

Opposite the threading arm 17 is the hook arm 22 (FIG. 7). Spatially, the hook arm 22 is preferably positioned parallel to the threading arm 17 and below the eye 26. The hook arm 22 is mainly thought to be composed of steel, however other embodiments may be composed of any of the following: high carbon steel, steel alloyed with Vanadium, stainless steel, fishing leader wire, or corrosion resistant steel. The hook arm 22 comprises the portion of the bait tackle device 11 there a hook is attached. The hook arm 22 allows one to use a treble hook with artificial or live bait. It also serves to allow one to change a treble hook with different bait types without cutting their line. Also, the hook arm 22 serves to allow one to use a three barb treble hook to be used with removable/threadable bait. The hook arm 22 preferably comprises the non-hook region 15 and the hook region 19. The hook arm 22 has multiple alternative embodiments herein termed the ‘right angle’ embodiment, the ‘straight’ embodiment, and the ‘extended arm’ embodiment.

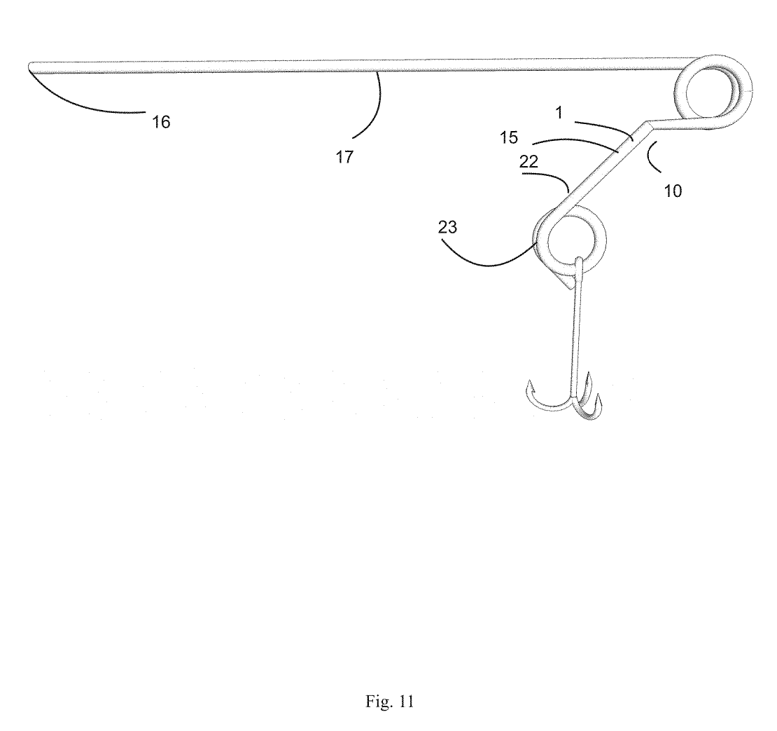

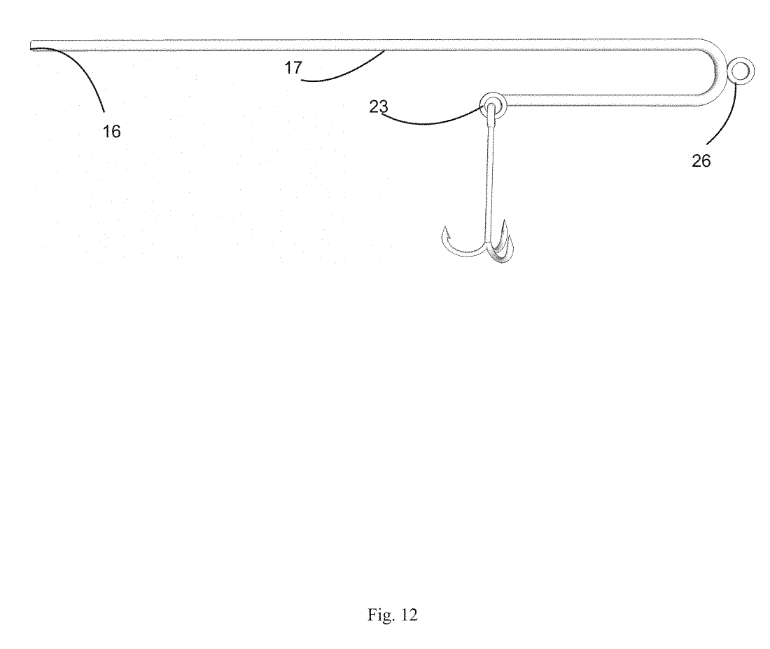

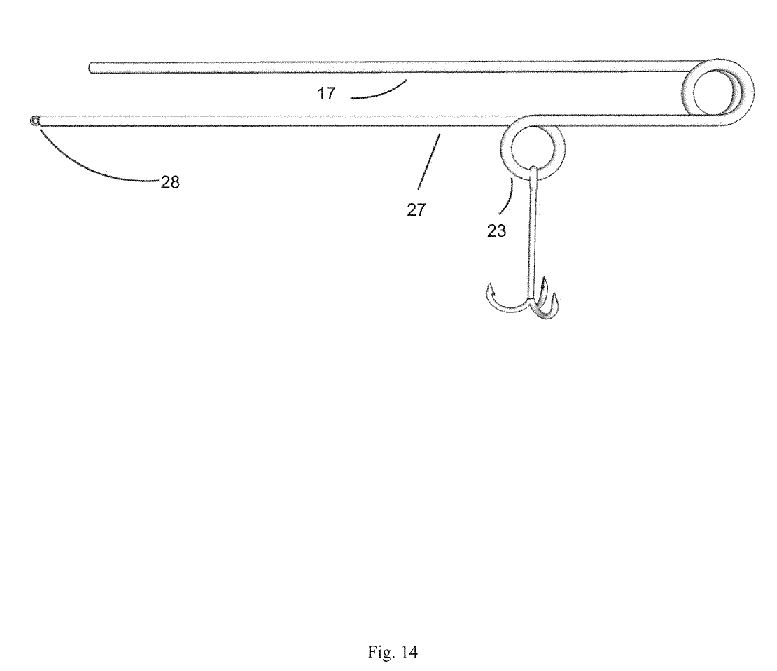

The ‘right angle’ embodiment (FIG. 11) comprises a right angle hook arm 10 wherein the hook arm is curved or at a oblique or right angle, where at the end of the curve the shank is parallel or non parallel with the threading arm. The ‘straight’ embodiment (FIG. 12) is one where the hook arm is straight, with no curves or bumps, ending with the hook eye 21. The ‘extended arm’ embodiment (FIG. 14) comprises the hook arm 22 wherein the entire hook arm is straight, with no curves or bumps, ending with the hook eye 21 and continues past the hook eye 21 onto an extended hook arm 22, so that one or more attachments such as spinner may be used. It comprises an extended hook arm eye 26. The extended hook arm eye 26 comprises the eye on the apical end of the extended hook arm 22 and may include: a ring eye, a ball eye, a brazed eye, a tapered eye, a looped eye, a needle eye, or a spade end.

The non-hook region (FIG. 7) of the hook arm is preferably positioned below the eye 26 and above the hook region 19. The non-hook region 15 comprises the portion of the hook region 19 that does not have a hook and has an attachment region. The non-hook region 15 allows one to interchange sinkers very quickly and also interchange various attachments quickly. The non-hook region 15 preferably comprises the non-hook front attachment region 1. Spatially, the hook region 19 (FIG. 7) is preferably positioned below the non-hook region 15 and comprises the portion of the hook arm 22 that allows one to attach a hook to the device. The hook region 19 preferably comprises the hook eye 21.

Typically prior to fishing, a person orients the bait insuch that the dorsal features of the bait are opposite that of the hook arm 22 and while fishing, the modularity of the device allows one to rapidly change tackle arrangements (FIG. 1). For example, if a person wants to change weight on the hook arm 22 a person removes the weight from the hook arm 22 or threading arm 17. If a person wants to change plastic bait on the threading arm 17, a person removes plastic bait from the threading arm 17. Or if a person wants to change live bait on the threading arm 17, a person removes live bait from the threading arm 17. Then a person may start at Step 102.

I claim:

1. A bait adapter device comprising:
an eye, said eye configured to connect to one or more components which may connect to a fishing line, a wire-shaped threading arm connected to said eye, a wire-shaped hook arm connected with said eye, said threading arm and said hook arm extending in substantially the same direction, said threading arm and said hook arm remaining separate from one another and ending in a threading arm end and a hook arm end, said threading arm end comprising a sharp point, said hook arm end comprising a hook eye.

2. The device of claim 1 wherein said adapter is made from a single continuos piece wherein said eye is formed from a loop between the threading arm and the hook arm.

3. The device of claim 1 wherein said adapter is made from more than piece otherwise attached to one another.

4. The device of claim 1 wherein said threading arm has one or more curves on the half of the threading arm closest to said eye.

5. The device of claim 1 wherein said threading arm has an angled turn on the half of the threading arm closest to said eye.

6. The device of claim 1 wherein said hook arm has one or more curves on the half of the hook arm closest to said eye.

7. The device of claim 1 wherein said hook arm has an angled turn on the half of the hook arm closest to said eye.

8. The device of claim 1 wherein said threading arm is straight.

9. The device of claim 8 wherein said hook arm is straight.

10. The device of claim 9 wherein said threading arm and said hook arm extending substantially in parallel to one another.

11. The device of claim 10 wherein said threading arm comprising an insertion point for bait at a second threading arm end.

12. The device of claim 11 wherein said hook arm comprising a hook arm eye at a second hook arm end.

13. The device of claim 12 wherein said threading arm is longer than said hook.

14. The device of claim 13 wherein said threading arm comprising a non bait threading region, wherein a front attachment is removably affixed.

15. The device of claim 14 wherein said front attachment may comprise one or more of the following; balls, beads, floats, an avon float, a bubble float, a dink float, a popper float, a quill float, a self-cocking float, a stick float, pyramid sinkers, barrel or egg sinkers, split-shot sinkers, bullet sinkers, a dipsey, a bank sinker, or a rattle.

16. The device of claim 13 wherein said hook arm comprising a non hook region, wherein a non hook attachment is removably affixed.

17. The device of claim 16 wherein said non hook attachment may comprise one or more of the following; balls, beads, floats, an avon float, a bubble float, a dink float, a popper float, a quill float, a self-cocking float, a stick float, pyramid sinkers, barrel or egg sinkers, split-shot sinkers, bullet sinkers, a dipsey, a bank sinker, or a rattle.

18. The device of claim 13 wherein said bait adapter is made of one of the following; high carbon steel, steel alloyed with Vanadium, stainless steel, fishing leader wire, or corrosion resistant steel.
